(19) United States
(12) Patent Application Publication
(10) Pub. No.: US 2023/0175416 A1
(43) Pub. Date: Jun. 8, 2023

(54) APPARATUSES FOR DEICING FAN BLADES AND METHODS OF FORMING THE SAME

(71) Applicant: General Electric Company, Schenectady, NY (US)

(72) Inventors: Li Zheng, Niskayuna, NY (US); Nicholas J. Kray, Evendale, OH (US); Changjie Sun, Clifton Park, NY (US)

(21) Appl. No.: 17/542,228

(22) Filed: Dec. 3, 2021

(51) Int. Cl. F01D 25/02; F01D 11/00

(52) U.S. Cl. CPC F01D 25/02; F01D 11/006; F05D 2240/55; F05D 2260/30; F05D 2260/606

(57) ABSTRACT

Methods, apparatus, systems, and articles of manufacture for deicing fan blades are disclosed. An example apparatus to de-ice a fan blade includes a fan cone including a cavity to hold pressurized hot air, the fan cone including a fan disk in the cavity, the fan disk coupled to the fan blade, and a dovetail seal coupled to the fan disk, the dovetail seal including at least one first hole, wherein the at least one first hole corresponds to at least one second hole in a root of the fan blade.

### FIELD OF THE DISCLOSURE

This disclosure relates generally to fan blades and, more particularly, to apparatuses for deicing fan blades and methods for forming the same.

### BACKGROUND

A gas turbine engine generally works with a turbofan to propel a machine. Typically, the turbofan includes a fan disk that is coupled to a plurality of fan blades that are rotated to generate a propulsive thrust. The fans blades are exposed to external conditions (e.g., extreme cold temperature, etc.). The external conditions typically causes icing on the fan blades during operation (e.g., the fan blades accumulate ice from moisture and the cold external environment).

### BRIEF DESCRIPTION OF THE DRAWINGS

FIG. 1 is a schematic cross-sectional view of an example gas turbine engine in accordance with the examples disclosed herein.

FIG. 2 is a schematic of an example fan section including an example heating airflow system in accordance with the examples disclosed herein.

FIG. 3 is a schematic of the example fan section of FIG. 2 including the example heating airflow system and an example hole in an example fan disk in accordance with the examples disclosed herein.

FIG. 4A is a schematic of an example fan disk including a plurality of holes in an example dovetail seal in accordance with the examples disclosed herein.

FIG. 4B is a schematic of an example castellated dovetail seal in accordance with the examples disclosed herein.

FIG. 5 is a flowchart representative of an example method to produce the example heating airflow system of FIG. 2.

FIG. 6 is a flowchart representative of an example method to produce the example heating airflow system of FIG. 2 with the example hole in the example fan disk of FIG. 3.

FIG. 7 is a flowchart representative of an example method to produce the example heating airflow system of FIG. 2 with the example plurality of holes in the example dovetail seal of FIG. 4A.

FIG. 8 is a flowchart representative of an example method to produce the example heating airflow system of FIG. 2 with the example castellated dovetail seal of FIG. 4B.

The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts. As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized. The following detailed description is therefore, provided to describe example implementations and not to be taken limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object.

As used herein, the terms “system,” “unit,” “module,” “engine,” etc., may include a hardware and/or software system that operates to perform one or more functions. For example, a module, unit, or system may include a computer processor, controller, and/or other logic-based device that performs operations based on instructions stored on a tangible and non-transitory computer readable storage medium, such as a computer memory. Alternatively, a module, unit, engine, or system may include a hard-wired device that performs operations based on hard-wired logic of the device. Various modules, units, engines, and/or systems shown in the attached figures may represent the hardware that operates based on software or hardwired instructions, the software that directs hardware to perform the operations, or a combination thereof.

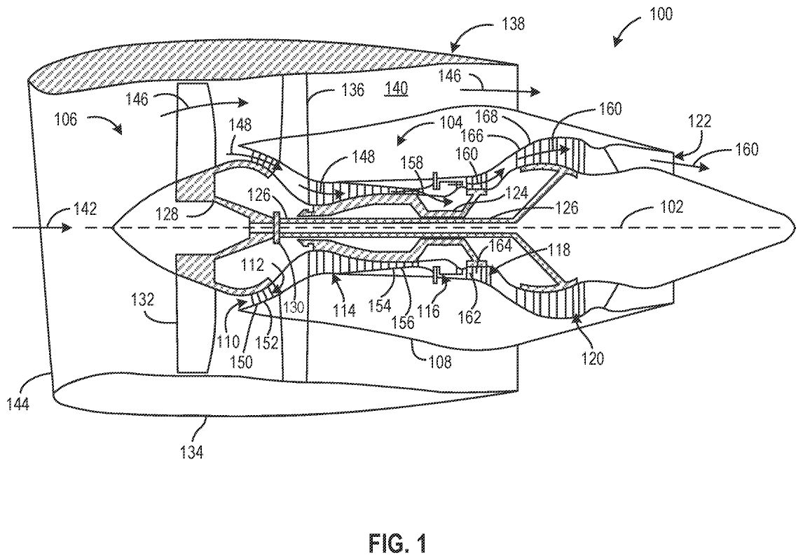

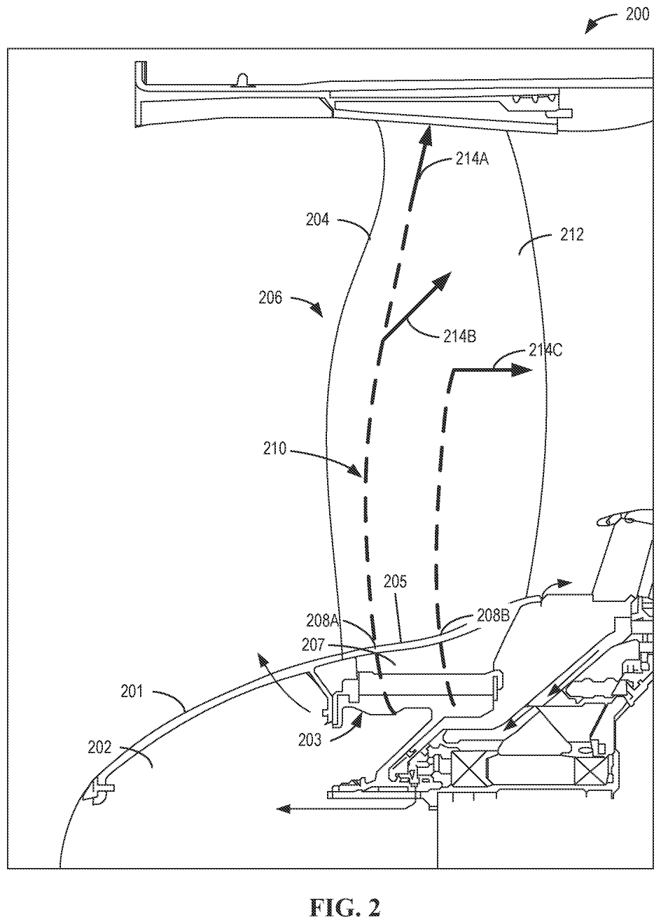

The terms “upstream” and “downstream” refer to the relative direction with respect to fluid flow in a fluid pathway. For example, “upstream” refers to the direction from which the fluid flows, and “downstream” refers to the direction to which the fluid flows. As used herein, “vertical” refers to the direction perpendicular to the ground. As used herein, “horizontal” refers to the direction parallel to the centerline of the gas turbine engine 100. As used herein, “lateral” refers to the direction perpendicular to the axial and vertical directions (e.g., into and out of the plane of FIGS. 1, 2, etc.).

In some examples used herein, the term “substantially” is used to describe a relationship between two parts that is within three degrees of the stated relationship (e.g., a substantially colinear relationship is within three degrees of being linear, a substantially perpendicular relationship is within three degrees of being perpendicular, a substantially parallel relationship is within three degrees of being parallel, etc.).

A turbine engine, also called a combustion turbine or a gas turbine, is a type of internal combustion engine. Turbine engines are commonly utilized in aircraft and power-generation applications. As used herein, the terms “asset,” “aircraft turbine engine,” “gas turbine,” “land-based turbine engine,” and “turbine engine” are used interchangeably. A basic operation of the turbine engine includes an intake of fresh atmospheric air flow through the front of the turbine engine with a fan. In some examples, the air flow travels through an intermediate-pressure compressor or a booster compressor located between the fan and a high-pressure compressor. A turbine engine also includes a turbine with an intricate array of alternating rotating and stationary airfoil-section blades. As the hot combustion gas passes through the turbine, the hot combustion gas expands, causing the rotating blades to spin.

Turbine engines also typically work with a turbofan to propel a machine. In some examples, hot air from turbine engine flow to a cavity in a fan cone section of the turbofan. The turbofan includes a fan disk that is coupled to a plurality of fan blades that are rotated to generate a propulsive thrust. The fans blades are exposed to external conditions (e.g., extreme cold temperature, etc.). The external conditions typically causes icing on the fan blades during operation (e.g., the fan blades accumulate ice from moisture and the cold external environment). In some examples, the revolutions per minute (rpm) of the fan disk is sped up to remove any ice accumulations on the fan blades.

However, in a geared turbofan configuration, the fan disk is coupled to a shaft that is driven by the turbine engine. In such examples, the fan rotor speed is at least one half less than the turbine engine. For example, a gear ratio between the fan and the low pressure turbine can be 2:1, 3:1, etc. In such examples, the rpm of the fan disk is unable to be sped up to an extent sufficient to remove ice accumulations on the fan blades. In some examples, the fan blades are solid in the root of the fan blades but also include hollow cavities throughout the internal areas of the fan blades. Examples disclosed herein use the hot air from the cavity in the fan cone section of the turbofan to bleed air into the hollow cavities of the fan blades to warm the surfaces of the fan blades. Examples disclosed herein prevent ice accumulations on the fan blades by warming the internal surfaces of the hollow cavities of the fan blades, which heat the external surfaces of the fan blades to prevent ice from forming on the external surfaces of the fan blades.

Examples disclosed herein bleed hot air into the cavity that holds the fan blade in the fan disk (e.g., the dovetail cavity). Examples disclosed herein generate (e.g., drill) holes in the root of the hollow fan blade to allow air to flow into hollow cavities of the fan blade from the dovetail cavity. Examples disclosed herein generate bleed ports to allow the hot air to flow into the dovetail cavity. In some examples, the bleed port is a slot in a bore of the fan cone cavity. In some examples, the bleed port is a hole in the dovetail seal of the fan disk. In some examples, the bleed port is a castellated surface of the dovetail seal or the fan disk. Examples disclosed herein bleed hot air (e.g., in the fan cone cavity from the turbine engine) into the dovetail cavity via the bleed port(s). Examples disclosed herein bleed the hot air in the dovetail cavity into the hollow cavities of the fan blade via the at least one hole in the root of the fan blade. In examples disclosed herein, after using the hot air in the hollow cavities of the fan blade to heat the surfaces of the fan blade, the hot air exits the fan blade. Examples disclosed herein expel the hot air in the hollow cavities of the fan blade at the trailing edge of the fan blade, the midspan of the fan blade, and/or at the tip of the fan blade.

Reference now will be made in detail to examples of the present disclosure, one or more examples of which are illustrated in the drawings. Each example is provided by way of explanation only, not limitation of the present disclosure. In fact, it will be apparent to those skilled in the art that various modifications and variations can be made in the preferred embodiments without departing from the scope or spirit of the present disclosure. For instance, features illustrated or described as part of one embodiment can be used with another embodiment to yield a still further embodiment. Thus, it is intended that the examples disclosed and described herein cover such modifications and variations as come within the scope of the appended claims and their equivalents.

FIG. 1 is a schematic cross-sectional view of a conventional turbofan-type gas turbine engine 100 (“turbofan 100”). As shown in FIG. 1, the turbofan 100 defines a longitudinal or axial centerline axis 102 extending therethrough for reference. In general, the turbofan 100 may include a core turbine or gas turbine engine 104 disposed downstream from a fan section 106.

The core turbine 104 generally includes a substantially tubular outer casing 108 that defines an annular inlet 110. The outer casing 108 can be formed from a single casing or multiple casings. The outer casing 108 encloses, in serial flow relationship, a compressor section having a booster or low pressure compressor 112 (“LP compressor 112”) and a high pressure compressor 114 (“HP compressor 114”), a combustion section 116, a turbine section having a high pressure turbine 118 (“HP turbine 118”) and a low pressure turbine 120 (“LP turbine 120”), and an exhaust section 122. A high pressure shaft or spool 124 (“HP shaft 124”) drivingly couples the HP turbine 118 and the HP compressor 114. A low pressure shaft or spool 126 (“LP shaft 126”) drivingly couples the LP turbine 120 and the LP compressor 112. The LP shaft 126 may also couple to a fan spool or shaft 128 of the fan section 106. In some examples, the LP shaft 126 may couple directly to the fan shaft 128 (i.e., a direct-drive configuration). In alternative configurations, the LP shaft 126 may couple to the fan shaft 128 via a reduction gearbox 130 (i.e., an indirect-drive or geared-drive configuration).

As shown in FIG. 1, the fan section 106 includes a plurality of fan blades 132 coupled to and extending radially outwardly from the fan shaft 128. An annular fan casing or nacelle 134 circumferentially encloses the fan section 106 and/or at least a portion of the core turbine 104. The nacelle 134 is supported relative to the core turbine 104 by a plurality of circumferentially-spaced apart outlet guide vanes 136. Furthermore, a downstream section 138 of the nacelle 134 can enclose an outer portion of the core turbine 104 to define a bypass airflow passage 140 therebetween.

As illustrated in FIG. 1, air 142 enters an inlet portion 144 of the turbofan 100 during operation thereof. A first portion 146 of the air 142 flows into the bypass airflow passage 140, while a second portion 148 of the air 142 flows into the inlet 110 of the LP compressor 112. One or more sequential stages of LP compressor stator vanes 150 and LP compressor rotor blades 152 coupled to the LP shaft 126 progressively compress the second portion 148 of the air 142 flowing through the LP compressor 112 en route to the HP compressor 114. Next, one or more sequential stages of HP compressor stator vanes 154 and HP compressor rotor blades 156 coupled to the HP shaft 124 further compress the second portion 148 of the air 142 flowing through the HP compressor 114. This provides compressed air 158 to the combustion section 116 where it mixes with fuel and burns to provide combustion gases 160.

The combustion gases 160 flow through the HP turbine 118 in which one or more sequential stages of HP turbine stator vanes 162 and HP turbine rotor blades 164 coupled to the HP shaft 124 extract a first portion of kinetic and/or thermal energy from the combustion gases 160. This energy extraction supports operation of the HP compressor 114. The combustion gases 160 then flow through the LP turbine 120 where one or more sequential stages of LP turbine stator vanes 166 and LP turbine rotor blades 168 coupled to the LP shaft 126 extract a second portion of thermal and/or kinetic energy therefrom. This energy extraction causes the LP shaft 126 to rotate, thereby supporting operation of the LP compressor 112 and/or rotation of the fan shaft 128. The combustion gases 160 then exit the core turbine 104 through the exhaust section 122 thereof.

Along with the turbofan 100, the core turbine 104 serves a similar purpose and operates in a similar environment in land-based gas turbines, turbojet engines in which the ratio of the first portion 146 of the air 142 to the second portion 148 of the air 142 is less than that of a turbofan, and unducted fan engines in which the fan section 106 is devoid of the nacelle 134. In each of the turbofan, turbojet, and unducted engines, a speed reduction device (e.g., the reduction gearbox 130) may be included between any shafts and spools. For example, the reduction gearbox 130 may be disposed between the LP shaft 126 and the fan shaft 128 of the fan section 106.

FIG. 2 is a schematic of an example fan section 200 including an example heating airflow system 206 in accordance with the examples disclosed herein. In the illustrated example of FIG. 2, the example fan section 200 is a geared turbofan configuration (e.g., fan rotor speed is at least one half less than the speed of the turbine engine). For example, a gear ratio between the fan and a low pressure turbine (e.g., the LP turbine 120 of FIG. 1) is 2:1, 3:1, etc. The fan section 200 includes an example fan cone 201 that includes an example fan cone cavity 202. The fan cone cavity 202 includes pressurized hot air from the turbine engine (e.g., the turbofan 100). For example, the pressurized hot air can be exhaust hot air or heated air from hydrogen fuel cells included in the turbine engine. In the illustrated example, the fan cone 201 includes an example fan disk 203 that rotates fan blades in the fan section 200 (e.g., an example hollow fan blade 204). In the illustrated example, the hollow fan blade 204 includes a solid root 205. That is, the root 205 may be solid (e.g., not hollow) in construction.

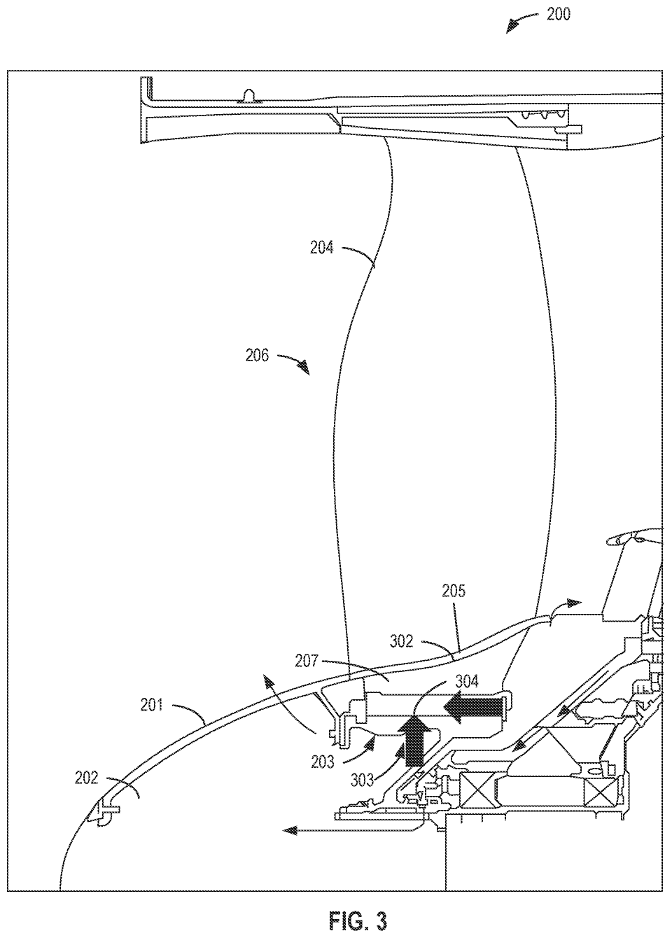

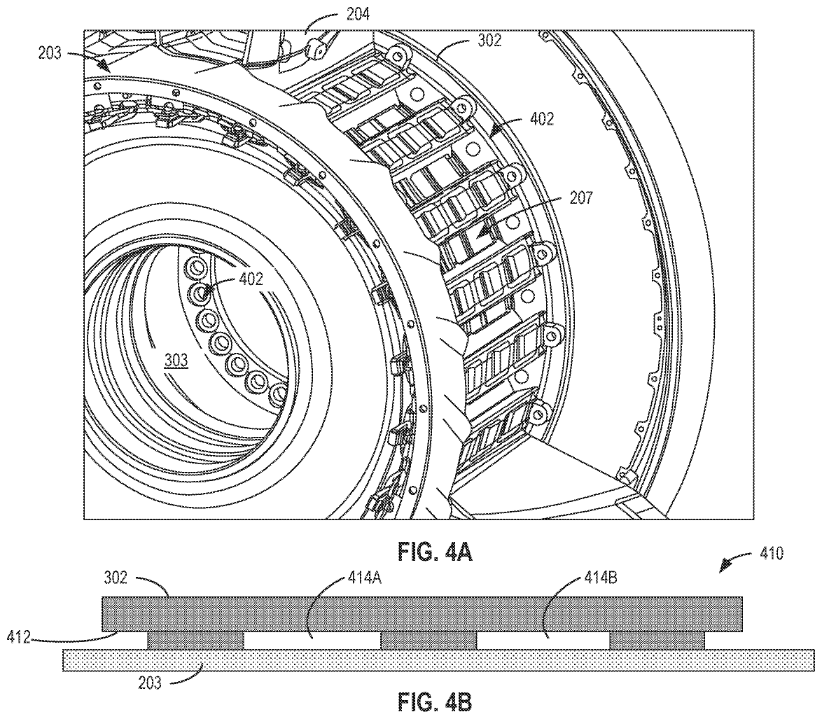

In the illustrated example, the fan section 200 further includes an example dovetail cavity 207 that is coupled to the fan cone 201 and the example hollow fan blade 204. In some examples, the dovetail cavity 207 is coupled to the fan disk 203 in the fan cone 201. In the heating airflow system 206 of FIG. 2, the fan cone cavity 202 transfers the pressurized hot air to the fan disk 203 and/or the dovetail cavity 207. In some examples, the fan disk 203 and/or the dovetail cavity 207 transfer the pressurized hot air to the hollow fan blade 204. Further details on the fan disk 203 and/or the dovetail cavity 207 transferring the pressurized hot air to the hollow fan blade 204 are described below in connection with FIGS. 3, 4A, 4B. In the heating airflow system 206, the hollow fan blade 204 includes holes 208A, 208B in the root 205. In some examples, the holes 208A, 208B are drilled into the root 205. The hollow fan blade 204 internally includes example air cavities 210. The air cavities 210 can be any shape, located in any internal location of the hollow fan blade 204, etc.

In some examples, the dovetail cavity 207 and/or the fan disk 203 transfer the pressurized hot air to the air cavities 210 via the holes 208A, 208B. In some examples, the hollow fan blade 204 includes a plurality of air cavities 210 throughout the entirety of the internal cavity of the hollow fan blade 204. In such examples, the dovetail cavity 207 and/or the fan disk 203 do not have to transfer the pressurized hot air to all of the available air cavities 210. In some examples, ice typically accumulates on a leading edge of the hollow fan blade 204. In such examples, the dovetail cavity 207 and/or the fan disk 203 may transfer the pressurized hot air to a selection of air cavities near a front/leading edge of the hollow fan blade 204. For example, the holes 208A, 208B may be located to direct the pressurized hot air to the air cavities 210 near a front/leading edge of the hollow fan blade 204 to remove/prevent ice accumulations.

In the heating airflow system 206, the air cavities 210 use the pressurized hot air to warm an example surface 212 of the hollow fan blade 204. In the illustrated example, the air cavities 210 warm the surface 212 to heat the hollow fan blade 204 and prevent ice from forming/accumulating on an external surface of the hollow fan blade 204. After warming the surface 212, the air cavities 210 expel the pressurized hot air from the hollow fan blade 204. The air cavities 210 expel the pressurized hot air via at least one of an example tip exit 214A of the hollow fan blade 204, an example surface exit 214B of the hollow fan blade 204, or an example trailing edge exit 214C of the hollow fan blade 204.

FIG. 3 is a schematic of the fan section 200 of FIG. 2 including the heating airflow system 206 and an example hole 304 in the fan disk 203 in accordance with the examples disclosed herein. In the illustrated example, the dovetail cavity 207 is coupled to the root 205 of the hollow fan blade 204. In the illustrated example, the dovetail cavity 207 is coupled to an example dovetail seal 302. In the illustrated example, the dovetail cavity 207 is contained between the fan disk 203 and the dovetail seal 302. In order to warm the surface of the hollow fan blade 204, the heating airflow system 206 is to transfer the pressurized hot air from the fan cone cavity 202 to the hollow fan blade 204. In the illustrated example, the hollow fan blade 204 obtains pressurized hot air from the fan cone cavity 202 via at least one bleed port. In the illustrated example of FIG. 3, the dovetail cavity 207 obtains the pressurized hot air via an example hole 304 in an example bore 303 of the fan disk 203. In some examples, the hole 304 is a radial hole in the fan disk 203 that allows pressurized hot air from the fan cone cavity 202 to enter the dovetail cavity 207. In the illustrated example, the bleed port (the hole 304) transfers the pressurized hot air to the dovetail cavity 207, which transfers the pressurized hot air to the air cavities (e.g., the air cavities 210 of FIG. 2) in the hollow fan blade 204 (e.g., via the holes 208A, 208B of FIG. 2). Additional examples of bleed ports are described in further detail below in connection with FIGS. 4A and 4B.

FIG. 4A is a schematic of the fan disk 203 including a plurality of holes 402 in the dovetail seal 302 in accordance with the examples disclosed herein. In the example heating airflow system 206, the hollow fan blade 204 obtains pressurized hot air from the fan cone cavity 202 via at least one bleed port. FIG. 4A illustrates the dovetail cavity 207 positioned outside the fan disk 203 where the hollow fan blade 204 is inserted. In the illustrated example of FIG. 4A, the bleed port is a plurality of holes 402 in the dovetail seal 302. The holes 402 allow the pressurized hot air from the fan cone cavity 202 to enter into the dovetail cavity 207. In the illustrated example, the bleed port (the holes 402 in the dovetail seal 302) transfers the pressurized hot air to the dovetail cavity 207, which transfers the pressurized hot air to the air cavities (e.g., the air cavities 210 of FIG. 2) in the hollow fan blade 204 (e.g., via the holes 208A, 208B of FIG. 2).

FIG. 4B is a schematic of an example castellated dovetail seal 410 in accordance with the examples disclosed herein. In the example heating airflow system 206, the hollow fan blade 204 obtains pressurized hot air from the fan cone cavity 202 via at least one bleed port. In the illustrated example of FIG. 4B, the bleed port is the castellated dovetail seal 410. The castellated dovetail seal 410 includes an example axial surface 412 on the dovetail seal 302 that is grooved. In the illustrated example, the grooves in the axial surface 412 of the dovetail seal 302 create example gaps 414A, 414B between the dovetail seal 302 and the fan disk 203. The gaps 414A, 414B allow the pressurized hot air from the fan cone cavity 202 to enter/seep into the dovetail cavity 207. In the illustrated example, the bleed port (castellated dovetail seal 410) transfers the pressurized hot air to the dovetail cavity 207, which transfers the pressurized hot air to the air cavities (e.g., the air cavities 210 of FIG. 2) in the hollow fan blade 204 (e.g., via the holes 208A, 208B of FIG. 2).

In some examples, the heating airflow system 206 includes means for obtaining pressurized hot air from a cavity in a fan cone (e.g., the fan cone cavity 202). For example, the means for obtaining may be implemented by the dovetail cavity 207. In some examples, the heating airflow system 206 includes means for transferring pressurized hot air from the dovetail cavity 207 to the hollow fan blade 204. For example, the means for obtaining may be implemented by the bleed port (e.g., the hole 304 in the fan disk 203, the holes 402 in the dovetail seal 302, the axial surface 412 of the dovetail seal 302). In some example, the heating airflow system 206 includes means for transferring pressurized hot air from the dovetail cavity 207 to air cavities 210 in the hollow fan blade 204 to warm the surface of the hollow fan blade 204. For example, the means for transferring may be implemented by the holes 208A, 208B in the root 205 of the hollow fan blade 204. In some examples, the heating airflow system 206 includes means for expelling the pressurized hot air from the hollow fan blade 204. For example, the means for expelling may be implemented by the air cavities 210.

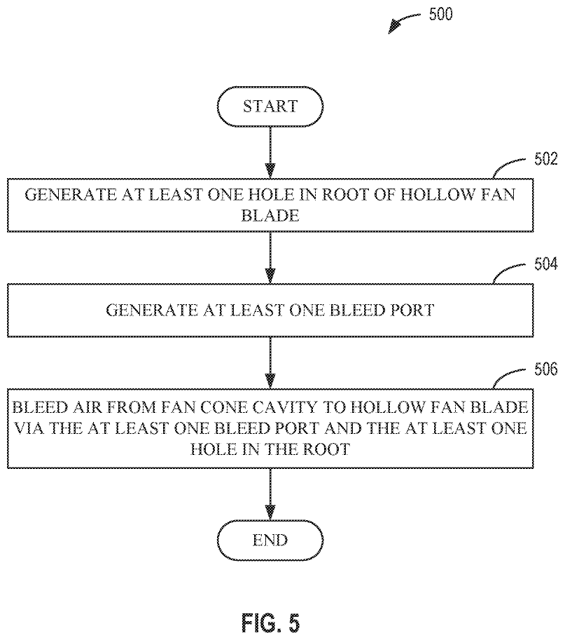

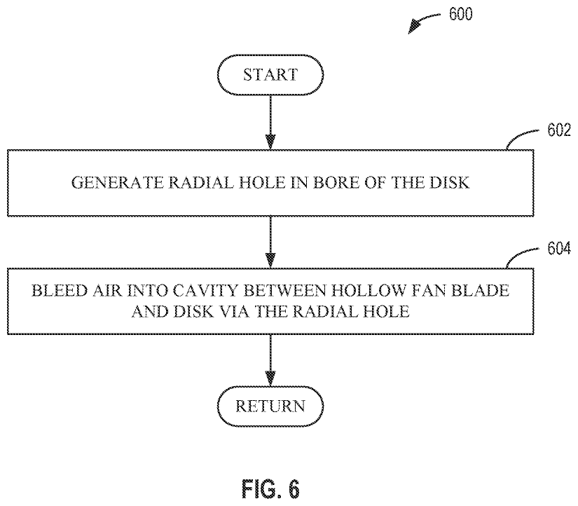

FIG. 5 is a flowchart representative of an example method 500 to produce the example heating airflow system 206 of FIG. 2. The example method 500 begins at block 502, at which at least one hole (e.g., the holes 208A, 208B) is generated in the root 205 of the hollow fan blade 204. At block 504, at least one bleed port is generated. Example methods of generating the at least one bleed port are described in further detail below in connection with FIGS. 6, 7, and 8. At block 506, air from the fan cone cavity 202 is bled into the hollow fan blade 204 via the at least one bleed port and the at least one hole (e.g., the holes 208A, 208B) in the root 205 of the hollow fan blade 204.

FIG. 6 is a flowchart representative of an example method 600 to produce the example heating airflow system 206 of FIG. 2 with the example hole 304 in the example fan disk 203 of FIG. 3. The example method 600 provides additional detail for an example of generating at least one bleed port (e.g., block 504 of the example method 500 of FIG. 5). The example method 600 of FIG. 6 begins at block 602, at which a radial hole (e.g., the hole 304) is generated in the bore 303 of the fan disk 203. In some examples, the at least one bleed port is the radial hole (e.g., the hole 304) in the bore 303. At block 604, air is bled into the cavity between the hollow fan blade 204 and the fan disk 203 (e.g., the dovetail cavity 207) via the radial hole (e.g., the hole 304).

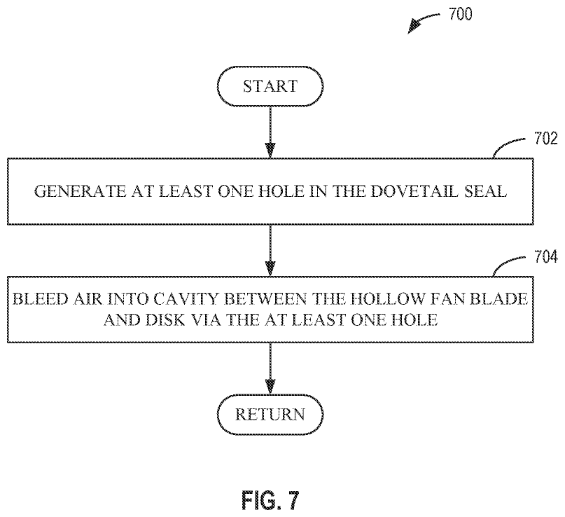

FIG. 7 is a flowchart representative of an example method 700 to produce the example heating airflow system 206 of FIG. 2 with the example plurality of holes 402 in the example dovetail seal 302 of FIG. 4A. The example method 700 provides additional detail for an example of generating at least one bleed port (e.g., block 504 of the example method 500 of FIG. 5). The example method 700 of FIG. 7 begins at block 702, at which at which at least one hole (e.g., the holes 402) is generated in the dovetail seal 302. In some examples, the at least one bleed port is the at least one hole (e.g., the holes 402) in the dovetail seal 302. At block 704, air is bled into the cavity between the hollow fan blade 204 and the fan disk 203 (e.g., the dovetail cavity 207) via the at least one hole (e.g., the holes 402).

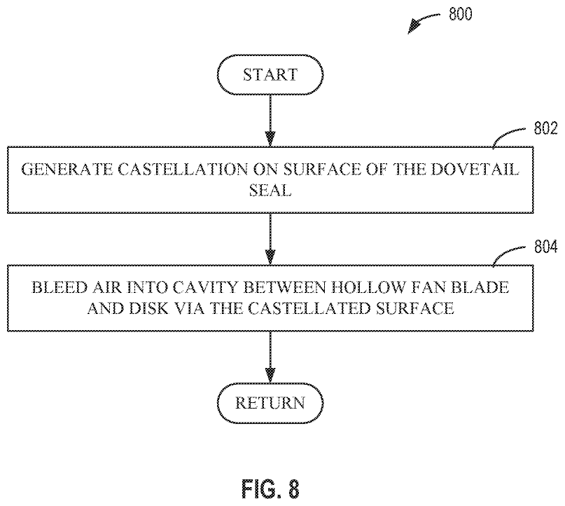

FIG. 8 is a flowchart representative of an example method 800 to produce the example heating airflow system 206 of FIG. 2 with the example castellated dovetail seal 410 of FIG. 4B. The example method 800 provides additional detail for an example of generating at least one bleed port (e.g., block 504 of the example method 500 of FIG. 5). The example method 800 of FIG. 8 begins at block 802, at which a castellation on an axial surface 412 of the dovetail seal 302 is generated. In some examples, the at least one bleed port is the castellation on the axial surface 412 of the dovetail seal 302. At block 804, air is bled into the cavity between the hollow fan blade 204 and the fan disk 203 (e.g., the dovetail cavity 207) via the castellated dovetail seal 410.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

From the foregoing, it will be appreciated that example systems, methods, apparatus, and articles of manufacture have been disclosed that improve ice accumulation removal on fan blades of a geared turbofan. The disclosed examples use the hot air from the cavity in the fan cone section of the turbofan to bleed air into hollow cavities of the fan blades to warm the surfaces of the fan blades. The disclosed examples bleed the hot air into a dovetail cavity in the turbofan via bleed port(s). The disclosed examples bleed the hot air in the dovetail cavity into the hollow cavities of the fan blade via at least one hole in the root of the fan blade. The disclosed examples prevent ice accumulations on the fan blades by warming the internal surfaces of the hollow cavities of the fan blades, which heat the external surfaces of the fan blades to prevent ice from forming on the external surfaces of the fan blades. The disclosed examples improve preventing ice accumulations on the fan blades of a geared turbofan by using hot air already present in the fan cone cavity of the turbofan to warm the surfaces of the hollow fan blades.

Further aspects of the invention are provided by the subject matter of the following clauses:

An apparatus to de-ice a fan blade, the apparatus comprising a fan cone including a cavity to hold pressurized hot air, the fan cone including a fan disk in the cavity, the fan disk coupled to the fan blade, and a dovetail seal coupled to the fan disk, the dovetail seal including at least one first hole, wherein the at least one first hole corresponds to at least one second hole in a root of the fan blade.

The apparatus of any preceding clause, wherein the cavity is connected to a turbine engine, and wherein the pressurized hot air is transferred from the turbine engine to the cavity, the pressurized hot air including at least one of exhaust hot air or heated air from hydrogen fuel cells included in the turbine engine.

The apparatus of any preceding clause, wherein the fan disk includes a dovetail cavity, and wherein the pressurized hot air is transferred from the cavity to the dovetail cavity via the at least one first hole in the dovetail seal.

The apparatus of any preceding clause, wherein the pressurized hot air is transferred to a plurality of air cavities in the fan blade from the dovetail cavity via the at least one second hole, the plurality of air cavities to use the pressurized hot air to warm a surface of the fan blade.

The apparatus of any preceding clause, wherein the pressurized hot air is expelled from the plurality of air cavities via at least one a tip of the fan blade, the surface of the fan blade, or a trailing edge of the fan blade.

The apparatus of any preceding clause, wherein the fan disk is coupled to a rotor of a gas turbine engine to rotate the fan blade, and wherein a first speed of the rotor is less than half a second speed of the gas turbine engine.

A dovetail apparatus to de-ice a fan blade, the dovetail apparatus comprising a coupling to connect to a fan disk in a cavity of a fan cone, and a dovetail seal coupled to the fan disk, the dovetail seal including at least one bleed port and a dovetail cavity between the fan disk and the fan blade, wherein pressurized hot air is transferred from the cavity of the fan cone to the dovetail cavity via the at least one bleed port.

The dovetail apparatus of any preceding clause, wherein the cavity is connected to a turbine engine, and wherein the pressurized hot air is transferred from the turbine engine to the cavity, the pressurized hot air including at least one of exhaust hot air or heated air from hydrogen fuel cells included in the turbine engine.

The dovetail apparatus of any preceding clause, wherein the at least one bleed port is at least one hole in the dovetail seal.

The dovetail apparatus of any preceding clause, wherein the at least one bleed port is a slot in a bore of the cavity.

The dovetail apparatus of any preceding clause, wherein the at least one bleed port is a castellated axial surface of at least one of the dovetail seal or the fan disk.

The dovetail apparatus of any preceding clause, wherein the fan disk is coupled to a rotor of a gas turbine engine to rotate the fan blade, and wherein a first speed of the rotor is less than half a second speed of the gas turbine engine.

An apparatus to de-ice a fan blade, the apparatus comprising a fan cone including a cavity to hold pressurized hot air, the fan cone including a fan disk in the cavity, the fan disk coupled to the fan blade, and a dovetail seal coupled to the fan disk, the dovetail seal to transfer the pressurized hot air from the cavity to a dovetail cavity, the dovetail seal including at least one bleed port, the at least one bleed port corresponding to at least one hole in a root of the fan blade, the at least one bleed port to transfer the pressurized hot air from the cavity to the dovetail cavity.

The apparatus of any preceding clause, wherein the cavity is connected to a turbine engine, and wherein the pressurized hot air is transferred from the turbine engine to the cavity, the pressurized hot air including at least one of exhaust hot air or heated air from hydrogen fuel cells included in the turbine engine.

The apparatus of any preceding clause, wherein the at least one bleed port is a plurality of holes in the dovetail seal.

The apparatus of any preceding clause, wherein the at least one bleed port is a slot in a bore of the fan disk.

The apparatus of any preceding clause, wherein the at least one bleed port is a castellated axial surface of at least one of the dovetail seal or the fan disk.

The apparatus of any preceding clause, wherein the pressurized hot air is transferred from the dovetail cavity to a plurality of air cavities in the fan blade via the at least one hole in the root of the fan blade, the plurality of air cavities to use the pressurized hot air to warm a surface of the fan blade.

The apparatus of any preceding clause, wherein the pressurized hot air is expelled from the plurality of air cavities via at least one a tip of the fan blade, the surface of the fan blade, or a trailing edge of the fan blade.

The apparatus of any preceding clause, wherein the fan disk is coupled to a rotor of a gas turbine engine to rotate the fan blade, and wherein a first speed of the rotor is less than half a second speed of the gas turbine engine.

A method to de-ice a fan blade, the method including generating at least one hole in a root of a fan blade coupled to a fan disk, generating at least one bleed port in a dovetail, and bleeding pressurized hot air from a fan cone cavity to the fan blade via the at least one bleed port and the at least one hole in the root.

The method of any preceding clause, wherein generating the at least one bleed port includes generating a hole in a bore of the fan cone cavity.

The method of any preceding clause, further including bleeding the pressurized hot air into a dovetail cavity via the hole in the bore of the fan cone cavity, wherein the dovetail cavity is between the fan disk and the fan blade.

The method of any preceding clause, further including transferring the pressurized hot air from the dovetail cavity to the fan blade via the at least one hole in the root of the fan blade.

A method to de-ice a fan blade, the method including generating at least one hole in a root of a fan blade coupled to a fan disk, generating at least one bleed port in a dovetail, and bleeding pressurized hot air from a fan cone cavity to the fan blade via the at least one bleed port and the at least one hole in the root.

The method of any preceding clause, wherein generating the at least one bleed port includes generating at least one hole in a dovetail seal, the dovetail seal coupled to the fan disk.

The method of any preceding clause, further including bleeding the pressurized hot air into a dovetail cavity via the at least one hole in the dovetail seal, wherein the dovetail cavity is between the fan disk and the fan blade.

The method of any preceding clause, further including transferring the pressurized hot air from the dovetail cavity to the fan blade via the at least one hole in the root of the fan blade.

A method to de-ice a fan blade, the method including generating at least one hole in a root of a fan blade coupled to a fan disk, generating at least one bleed port in a dovetail, and bleeding pressurized hot air from a fan cone cavity to the fan blade via the at least one bleed port and the at least one hole in the root.

The method of any preceding clause, wherein generating the at least one bleed port includes generating a castellated axial surface of at least one of the dovetail seal or the fan disk.

The method of any preceding clause, further including bleeding the pressurized hot air into a dovetail cavity via the castellated axial surface, wherein the dovetail cavity is between the fan disk and the fan blade.

The method of any preceding clause, further including transferring the pressurized hot air from the dovetail cavity to the fan blade via the at least one hole in the root of the fan blade.

A heating airflow system to de-ice a fan blade, the heating airflow system comprising a fan cone including a cavity to hold pressurized hot air, the fan cone including a fan disk in the cavity, the fan disk coupled to the fan blade, and a dovetail seal coupled to the fan disk, the dovetail seal to transfer the pressurized hot air from the cavity to a dovetail cavity, the dovetail seal including at least one bleed port, the at least one bleed port corresponding to at least one hole in a root of the fan blade, the at least one bleed port to transfer the pressurized hot air from the cavity to the dovetail cavity

The heating airflow system of any preceding clause, wherein the cavity is connected to a turbine engine, and wherein the pressurized hot air is transferred from the turbine engine to the cavity, the pressurized hot air including at least one of exhaust hot air or heated air from hydrogen fuel cells included in the turbine engine.

The heating airflow system of any preceding clause, wherein the at least one bleed port is a plurality of holes in the dovetail seal.

The heating airflow system of any preceding clause, wherein the at least one bleed port is a slot in a bore of the fan disk.

The heating airflow system of any preceding clause, wherein the at least one bleed port is a castellated axial surface of at least one of the dovetail seal or the fan disk.

The heating airflow system of any preceding clause, wherein the pressurized hot air is transferred from the dovetail cavity to a plurality of air cavities in the fan blade via the at least one hole in the root of the fan blade, the plurality of air cavities to use the pressurized hot air to warm a surface of the fan blade.

The heating airflow system of any preceding clause, wherein the pressurized hot air is expelled from the plurality of air cavities via at least one a tip of the fan blade, the surface of the fan blade, or a trailing edge of the fan blade.

The heating airflow system of any preceding clause, the fan disk is coupled to a rotor of a gas turbine engine to rotate the fan blade, and wherein a first speed of the rotor is less than half a second speed of the gas turbine engine.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. A de-icing apparatus, the de-icing apparatus comprising:
a fan blade having a root, a surface, and a tip;
a fan cone including a fan cone cavity to hold pressurized hot air, the fan cone including a fan disk in the fan cone cavity, the fan disk coupled to the fan blade;
a dovetail seal coupled to the fan disk, the dovetail seal including at least one first hole, wherein the at least one first hole corresponds to at least one second hole in the root of the fan blade;
a dovetail cavity formed at the root of the fan blade wherein the pressurized hot air is transferred from the fan cone cavity to the dovetail cavity via the at least one first hole in the dovetail seal; and
a plurality of air cavities formed in the fan blade to extend from the dovetail cavity into the fan blade and accessible through the at least one second hole, the plurality of air cavities to use the pressurized hot air to warm the surface of the fan blade by expelling the pressurized hot air from the plurality of air cavities via at least one of the tip of the fan blade or the surface of the fan blade.

2. The de-icing apparatus of claim 1, wherein the fan cone cavity is connected to a turbine engine, and wherein the pressurized hot air is transferred from the turbine engine to the fan cone cavity, the pressurized hot air including at least one of exhaust hot air or heated air from hydrogen fuel cells included in the turbine engine.

3. (canceled)

4. (canceled)

5. (canceled)

6. The de-icing apparatus of claim 1, wherein the fan disk is coupled to a rotor of a gas turbine engine to rotate the fan blade, and wherein a first speed of the rotor is less than half a second speed of the gas turbine engine.

7. A dovetail apparatus to de-ice a fan blade, the dovetail apparatus comprising:
a coupling to connect to a fan disk in a fan cone cavity;
a dovetail seal coupled to the fan disk, the dovetail seal including at least one bleed port and a dovetail cavity between the fan disk and the fan blade, wherein pressurized hot air is transferred from the fan cone cavity to the dovetail cavity via the at least one bleed port; and
a plurality of air cavities formed in the fan blade to extend from the dovetail cavity into the fan blade, the plurality of air cavities to terminate at one of a tip of the fan blade or a surface of the fan blade.

8. The dovetail apparatus of claim 7, wherein the fan cone cavity is connected to a turbine engine, and wherein the pressurized hot air is transferred from the turbine engine to the fan cone cavity, the pressurized hot air including at least one of exhaust hot air or heated air from hydrogen fuel cells included in the turbine engine.

9. The dovetail apparatus of claim 7, wherein the at least one bleed port is at least one hole in the dovetail seal.

10. The dovetail apparatus of claim 7, wherein the at least one bleed port is a slot in a bore of the fan cone cavity.

11. The dovetail apparatus of claim 7, wherein the at least one bleed port is a castellated axial surface of at least one of the dovetail seal or the fan disk.

12. The dovetail apparatus of claim 7, wherein the fan disk is coupled to a rotor of a gas turbine engine to rotate the fan blade, and wherein a first speed of the rotor is less than half a second speed of the gas turbine engine.

13. A de-icing apparatus, the de-icing apparatus comprising:
a fan blade including a root, a tip, and a surface;
a fan cone including a fan cone cavity to hold pressurized hot air, the fan cone including a fan disk in the fan cone cavity, the fan disk coupled to the fan blade;
a dovetail seal coupled to the fan disk, the dovetail seal to transfer the pressurized hot air from the fan cone cavity to a dovetail cavity, the dovetail seal including at least one bleed port, the at least one bleed port corresponding to an at least one hole in the root of the fan blade, the at least one bleed port to transfer the pressurized hot air from the fan cone cavity to the dovetail cavity; and
a plurality of air cavities formed in the fan blade to extend from the dovetail cavity into the fan blade and accessible through the at least one hole in the root of the fan blade, the plurality of air cavities to use the pressurized hot air to warm the surface of the fan blade by expelling the pressurized hot air from the plurality of air cavities via at least one of the tip of the fan blade or the surface of the fan blade.

14. The de-icing apparatus of claim 13, wherein the fan cone cavity is connected to a turbine engine, and wherein the pressurized hot air is transferred from the turbine engine to the fan cone cavity, the pressurized hot air including at least one of exhaust hot air or heated air from hydrogen fuel cells included in the turbine engine.

15. The de-icing apparatus of claim 13, wherein the at least one bleed port is a plurality of holes in the dovetail seal.

16. The de-icing apparatus of claim 13, wherein the at least one bleed port is a slot in a bore of the fan disk.

17. The de-icing apparatus of claim 13, wherein the at least one bleed port is a castellated axial surface of at least one of the dovetail seal or the fan disk.

18. (canceled)

19. (canceled)

20. The de-icing apparatus of claim 13, wherein the fan disk is coupled to a rotor of a gas turbine engine to rotate the fan blade, and wherein a first speed of the rotor is less than half a second speed of the gas turbine engine.
